(19) United States
(12) Patent Application Publication
(10) Pub. No.: US 2004/0139922 A1
(43) Pub. Date: Jul. 22, 2004

(54) Adjustable kennel system

(76) Inventors: Robert D. Kost, Moorhead, MN (US); Gretchen K.C. Kost, Moorhead, MN (US)

Correspondence Address: Michael S. Neustel, Suite No. 4, 2534 South University Drive, Fargo, ND, 58103, US

(21) Appl. No.: 10/629,050

(22) Filed: Jul. 29, 2003

Related U.S. Application Data
(63) Continuation-in-part of application No. 10/349,875, filed on Jan. 21, 2003.

(51) Int. Cl. A01K 1/02; A01K 1/03; A01K 31/00

(52) U.S. Cl. 119/482

(57) ABSTRACT

An adjustable kennel system for adjusting the interior space of an animal kennel. The adjustable kennel system includes a kennel having a lower portion and an upper portion, a plurality of first guide slots and a plurality of second guide slots in opposition to one another within the interior of the kennel. A partition member is selectively received within the guide slots for determining the relative size of the interior of the kennel.

### CROSS REFERENCE TO RELATED APPLICATIONS

I hereby claim benefit under Title 35, United States Code, Section 120 of U.S. patent application Ser. No. 10/349,875 filed Jan. 21, 2003. This application is a continuation-in-part of the Ser. No. 10/349,875 application. The Ser. No. 10/349,875 application is currently pending. The Ser. No. 10/349,875 application is hereby incorporated by reference into this application.

### STATEMENT REGARDING FEDERALLY SPONSORED RESEARCH OR DEVELOPMENT

Not applicable to this application.

### BACKGROUND OF THE INVENTION

1. Field of the Invention

The present invention relates generally to animal kennels and more specifically it relates to an adjustable kennel system for adjusting the interior space of an animal kennel.

2. Description of the Related Art

Animal kennels have been in use for years. A conventional animal kennel is illustrated in FIG. 6 of the drawings disclosing a lower portion, an upper portion defining an interior cavity, and a front opening. Animal kennels are created in various sizes and shapes which is well known in the art. A conventional animal kennel further typically includes air holes within the upper portion and sometimes the lower portion for providing ventilation to the animal within the animal kennel. A door is pivotally attached to the animal kennel that allows for selective closing of the front opening.

The main problem with conventional kennels is that they are not adjustable for various sizes of animals. A further problem with conventional kennels is that the owner of a young pet must purchase additional larger sized kennels as the animal increases in size which can be costly. Another problem with conventional kennels is that when an animal is relatively small compared to the kennel, it can be difficult to train the animal not to urinate or defecate within the interior of the kennel.

Examples of patented devices that may be related to the present invention include U.S. Pat. No. 4,991,543 to Silberman; U.S. Pat. No. 6,302,061 to Weatherby et al.; U.S. Pat. No. 5,960,744 to Rutman; U.S. Pat. No. 5,671,697 to Rutman; and U.S. Pat. No. 5,054,426 to Panarelli et al.

While these devices may be suitable for the particular purpose to which they address, they are not as suitable for adjusting the interior space of an animal kennel. Conventional animal kennels do not allow for the user to adjust the interior space of the kennel.

In these respects, the adjustable kennel system according to the present invention substantially departs from the conventional concepts and designs of the prior art, and in so doing provides an apparatus primarily developed for the purpose of adjusting the interior space of an animal kennel.

### BRIEF SUMMARY OF THE INVENTION

In view of the foregoing disadvantages inherent in the known types of animal kennels now present in the prior art, the present invention provides a new adjustable kennel system construction wherein the same can be utilized for adjusting the interior space of an animal kennel.

The general purpose of the present invention, which will be described subsequently in greater detail, is to provide a new adjustable kennel system that has many of the advantages of the animal kennels mentioned heretofore and many novel features that result in a new adjustable kennel system which is not anticipated, rendered obvious, suggested, or even implied by any of the prior art animal kennels, either alone or in any combination thereof.

To attain this, the present invention generally comprises a kennel having a lower portion and an upper portion, a plurality of first guide slots and a plurality of second guide slots in opposition to one another within the interior of the kennel. A partition member is selectively received within the guide slots for determining the relative size of the interior of the kennel.

There has thus been outlined, rather broadly, the more important features of the invention in order that the detailed description thereof may be better understood, and in order that the present contribution to the art may be better appreciated. There are additional features of the invention that will be described hereinafter and that will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

A primary object of the present invention is to provide an adjustable kennel system that will overcome the shortcomings of the prior art devices.

A second object is to provide an adjustable kennel system for adjusting the interior space of an animal kennel.

Another object is to provide an animal kennel sizing system that assists in training an animal not to urinate or defecate within the kennel.

An additional object is to provide an animal kennel sizing system that allows a kennel of a larger size to be adjusted to properly receive the animal.

A further object is to provide an animal kennel sizing system that may be utilized within various sizes, styles and structures of animal kennels.

Another object is to provide an animal kennel sizing system that provides a cost effective solution for pet owners to avoid having to purchase multiple kennels.

A further object is to provide an animal kennel sizing system that assists in house training an animal.

Another object is to provide an animal kennel sizing system that is stable, safe and sanitary.

Other objects and advantages of the present invention will become obvious to the reader and it is intended that these objects and advantages are within the scope of the present invention.

To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is an exploded upper perspective view of the present invention.

FIG. 2 is an exploded upper perspective view of the lower portion of the kennel and the partition member removed.

FIG. 3 is an exploded upper perspective view of the partition member being inserted into the lower portion of the kennel.

FIG. 4 is an upper perspective view of the partition member inserted within the guide slots of the lower portion of the kennel.

FIG. 5 is an upper perspective view of the present invention fully assembled.

FIG. 6 is a top view of the lower portion with the partition member positioned within.

### DETAILED DESCRIPTION OF THE INVENTION

A. Overview

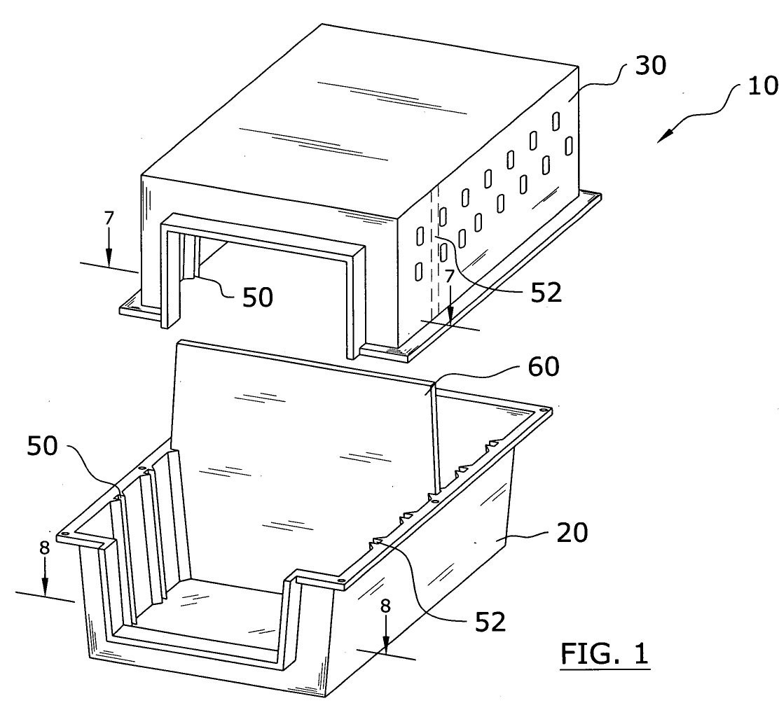

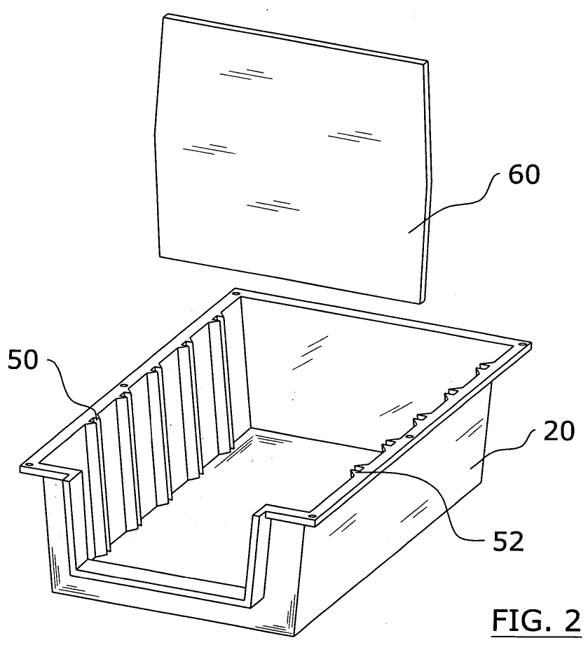

Turning now descriptively to the drawings, in which similar reference characters denote similar elements throughout the several views, FIGS. 1 through 8 illustrate an adjustable kennel system 10, which comprises a kennel having a lower portion 20 and an upper portion 30, a plurality of first guide slots 50 and a plurality of second guide slots 52 in opposition to one another within the interior of the kennel. A partition member 60 is selectively received within the guide slots for determining the relative size of the interior of the kennel.

B. Kennel

The kennel may be comprised of various structures and shapes commonly utilized in the animal confinement industry. The kennel preferably has a lower portion 20 and an upper portion 30, wherein the upper portion 30 is removably attachable to the lower portion 20 forming an interior cavity as shown in FIGS. 1 through 5 of the drawings. The upper portion 30 may be secured to the lower portion 20 of the kennel via various conventional fastener devices which are commonly utilized within the animal confinement industry.

The lower portion 20 preferably has a structure that is tapered downwardly as shown in FIGS. 1 through 5 of the drawings. In addition, the lower portion 20 of the kennel preferably has a lower cutout that mates with an upper cutout within the upper portion 30 to form a front opening within the kennel as further shown in FIGS. 1 through 5 of the drawings.

The upper portion 30 preferably has a structure that is tapered upwardly as shown in FIGS. 1 through 5 of the drawings. In addition, the upper portion 30 of the kennel preferably has an upper cutout that mates with a lower cutout within the lower portion 20 to form a front opening within the kennel as further shown in FIGS. 1 through 5 of the drawings. A door is preferably attached to the kennel for allowing selective closing of the front opening within the kennel as shown in FIG. 5 of the drawings.

C. Guide Slots

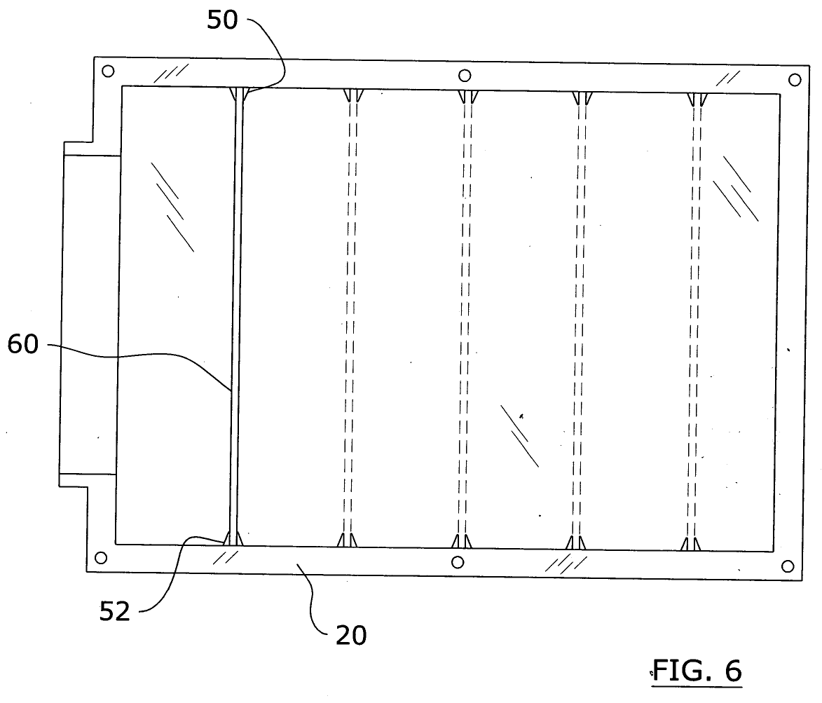

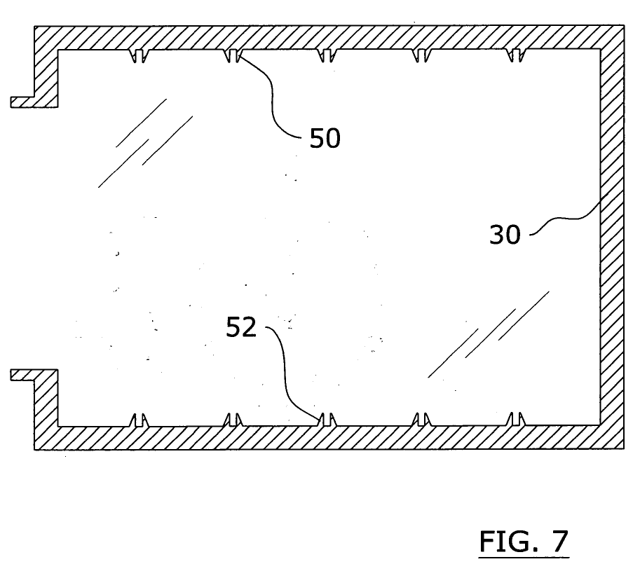

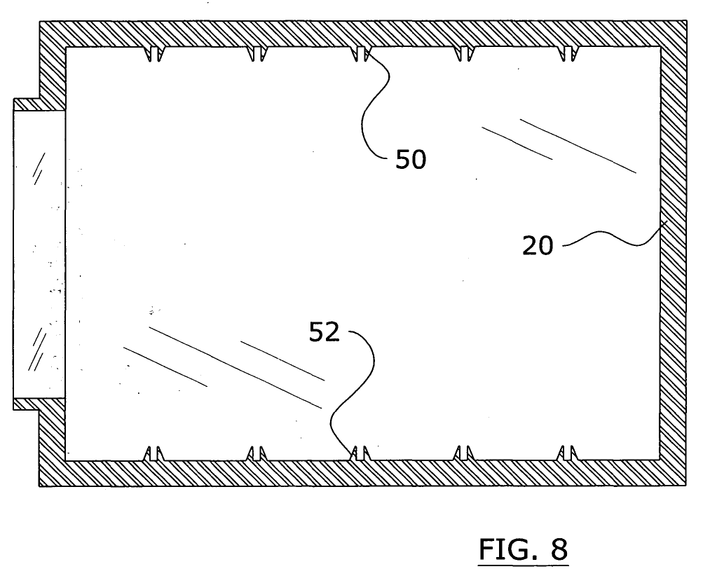

As shown in FIGS. 1 through 4 and 6 of the drawings, a plurality of first guide slots 50 and a plurality of second guide slots 52 are within the interior of the kennel for receiving the partition member 60. The guide slots 50, 52 are preferably in opposition to one another as best illustrated in FIGS. 6 through 8 of the drawings.

The guide slots 50, 52 are positioned within the lower portion 20 and the upper portion 30 of the kennel. It can be appreciated that the guide slots 50, 52 may only be positioned within the lower portion 20 or the upper portion 30 of the kennel. As best shown in FIG. 5 of the drawings, the guide slots 50, 52 are positioned within the upper portion 30 of the kennel corresponding to the guide slots 50, 52 within the lower portion 20 of the kennel.

As shown in FIGS. 1 through 8 of the drawings, the guide slots 50, 52 are preferably vertically oriented. In addition, the guide slots 50, 52 preferably are formed so as to frictionally receive the partition member 60. The guide slots 50, 52 may be formed by extending a slot into the portions 20, 30 or by a pair of opposing side ridges.

As best shown in FIG. 6 of the drawings, the guide slots 50, 52 are distally spaced apart to allow for various interior sizes of the kennel. The guide slots 50, 52 are preferably equidistantly spaced apart. However, varying distances may be utilized.

D. Partition Member

One or more partition members 60 are selectively received within a set of the guide slots 50, 52 as shown in FIGS. 1 through 6 of the drawings. The partition member 60 either completely or partially separates the kennel into a front portion accessible by the front opening within the kennel and a rear portion non-accessible.

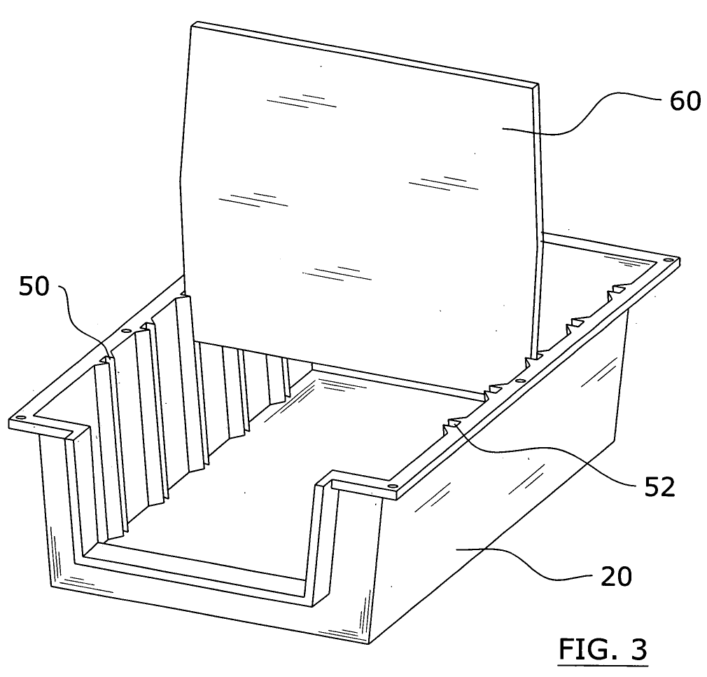

The partition member 60 may be comprised of various structures such as a solid structure, a ventilated structure, a reticulated structure and various other structures suitable to maintain an animal within the front portion of the kennel. The partition member 60 is preferably formed to the shape of the lower portion 20 and the upper portion 30 of the kennel as shown in FIGS. 1 through 5 of the drawings. More particularly, the partition preferably has an upper part that tapers upwardly and a lower part that tapers downwardly as shown in FIG. 2 of the drawings.

E. Operation

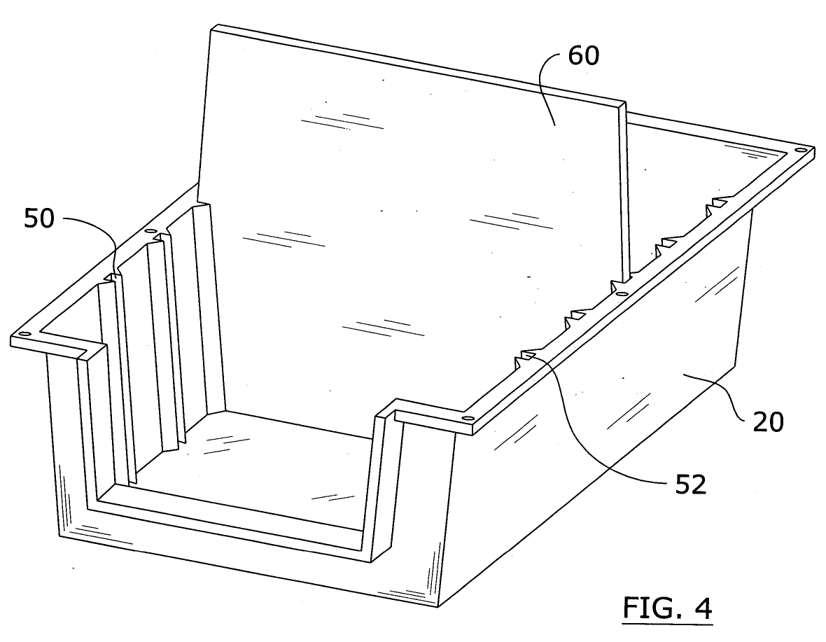

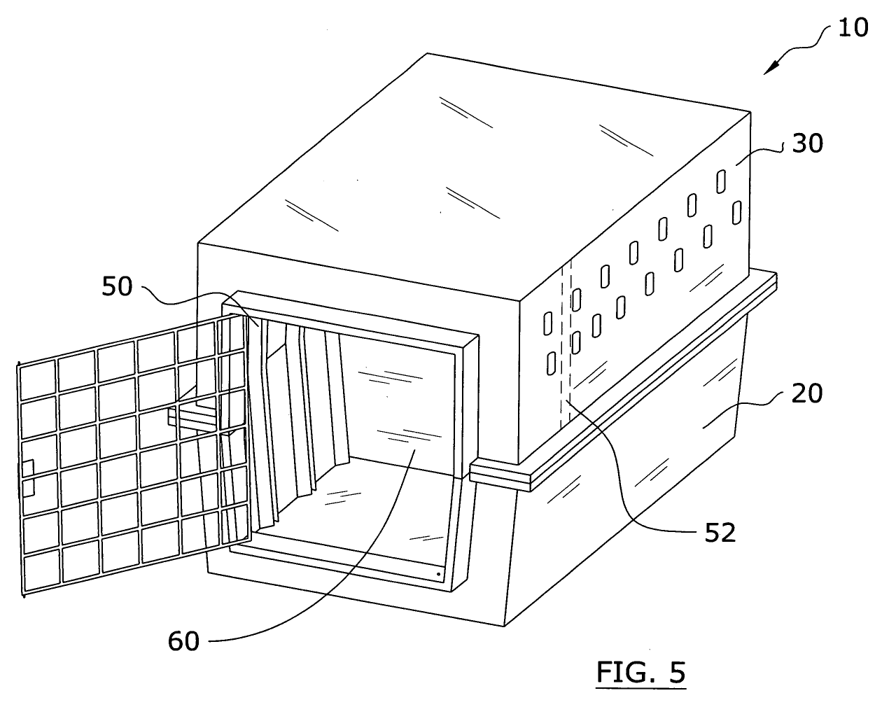

In use, the user first removes the upper portion 30 from the lower portion 20 of the kennel as illustrated in FIG. 1 of the drawings. The user then determines the desired interior size (i.e. front portion) of the kennel and selects the guide slots 50, 52 that correspond to the desired space. The user then positions the partition member 60 within the selected guide slots within the lower portion 20 of the kennel as shown in FIGS. 3 and 4 of the drawings. The user then secures the upper portion 30 of the kennel to the lower portion 20 of the kennel as shown in FIGS. 1 and 5 of the drawings.

The user then positions the animal(s) within the front interior portion of the kennel through the front opening wherein the interior size of the kennel has been effectively reduced as shown in FIG. 5 of the drawings. When the animal increases in size and outgrows the interior space, the user then simply moves the partition member 60 to the next desired location thereby increasing the interior size of the kennel. This process continues until the animal is fully grown.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed to be within the expertise of those skilled in the art, and all equivalent structural variations and relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

We claim:

1. An adjustable kennel system, comprising:
a kennel having a lower portion and an upper portion;
a plurality of first guide slots and a plurality of second guide slots in opposition to one another within an interior of said kennel; and
a partition member selectively received within a set of said guide slots.

2. The adjustable kennel system of claim 1, wherein said guide slots are positioned within said lower portion of said kennel.

3. The adjustable kennel system of claim 2, wherein said guide slots are positioned within said upper portion of said kennel corresponding to said guide slots within said lower portion of said kennel.

4. The adjustable kennel system of claim 1, wherein said guide slots are distally spaced apart to allow for various interior sizes of said kennel.

5. The adjustable kennel system of claim 1, wherein said guide slots are equidistantly spaced apart to allow for various interior sizes of said kennel.

6. The adjustable kennel system of claim 1, wherein said guide slots are vertically oriented.

7. The adjustable kennel system of claim 1, wherein a pair of opposing side ridges form said guide slots.

8. The adjustable kennel system of claim 1, wherein said guide slots extend into said lower portion and said upper portion.

9. The adjustable kennel system of claim 1, wherein said guide slots frictionally receive said partition member.

10. The adjustable kennel system of claim 1, wherein said partition member completely separates said kennel into a front portion accessible by a front opening within said kennel and a rear portion non-accessible.

11. An adjustable kennel system, comprising:
a kennel having a lower portion and an upper portion, wherein said upper portion is removably attachable to said lower portion forming an interior cavity;
a plurality of first guide slots and a plurality of second guide slots in opposition to one another within an interior of said kennel; and
a partition member selectively received within a set of said guide slots.

12. The adjustable kennel system of claim 11, wherein said guide slots are positioned within said lower portion of said kennel.

13. The adjustable kennel system of claim 12, wherein said guide slots are positioned within said upper portion of said kennel corresponding to said guide slots within said lower portion of said kennel.

14. The adjustable kennel system of claim 11, wherein said guide slots are distally spaced apart to allow for various interior sizes of said kennel.

15. The adjustable kennel system of claim 11, wherein said guide slots are equidistantly spaced apart to allow for various interior sizes of said kennel.

16. The adjustable kennel system of claim 11, wherein said guide slots are vertically oriented.

17. The adjustable kennel system of claim 11, wherein a pair of opposing side ridges form said guide slots.

18. The adjustable kennel system of claim 11, wherein said guide slots extend into said lower portion and said upper portion.

19. The adjustable kennel system of claim 11, wherein said guide slots frictionally receive said partition member.

20. A method of utilizing an adjustable kennel system, said method comprising the steps of:
(a) removing an upper portion from a lower portion of a kennel;
(b) positioning a partition member within a selected set of guide slots within said kennel thereby forming a front portion and a rear portion within an interior of said kennel; and
(c) securing said upper portion to said lower portion of said kennel.
